(19) United States
(12) Patent Application Publication
(10) Pub. No.: US 2006/0245306 A1
(43) Pub. Date: Nov. 2, 2006

(54) Data storage device and a method of generating a motor control signal therefor

(75) Inventors: Bart Michiel De Boer, Eindhoven (NL); Ivon Franciscus Helwegen, Eindhoven (NL); Steven Broeils Luitjens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/555,840

(22) PCT Filed: May 5, 2004
(86) PCT No.: PCT/IB04/50595

§ 371 Date: Nov. 3, 2005

(30) Foreign Application Priority Data
May 8, 2003 (EP) 03101278.4

(51) Int. Cl. H04B 1/20

(52) U.S. Cl. 369/1

(57) ABSTRACT

The invention relates to a data storage device (101) which comprises a data interface (103) for reading data from a spinning data storage disc (105). The data storage device (101) comprises a motor (111) for spinning the data storage disc (105) at a desired speed. The data storage device (101) further comprises a speed change processor (115) for determining a preferred motor speed change time; and a motor controller (113) for controlling the motor (111) to perform the speed change in response to the preferred motor speed change time. Specifically, the preferred motor speed change time resulting in the lowest energy consumption for disc spin-up and jump operations are determined, and the motor (111) is controlled to change the speed substantially within the preferred motor speed change time. The invention is particularly suitable for Small Form Factor Optical (SFFO) disc systems and allows for reduced energy consumption and thus increased battery life.

The invention relates to a data storage device and a method of generating a motor control signal therefore and in particular for a data storage device for a spinning data storage disc.

In recent years, there has been a general trend towards reduced size and increased mobility for much consumer equipment. For example, the use of portable phones, computers, personal music systems and personal digital Assistants (PDAs) have become increasingly widespread.

Typically, these small portable devices comprise significant amount of computational resources and are capable of processing large amounts of data. Furthermore, most devices comprise means for reading data from or writing data to external removable data media.

An example of a very high-density removable data storage medium is an optical disc, and it is therefore desirable in many small devices to include a data storage device for reading or writing optical discs.

As many small portable devices are limited by the available energy supply, which is typically only available from rechargeable batteries having a limited capacity, one of the most important parameters for portable devices is their power consumption. In order to achieve a long battery life and a small physical size of the batteries, it is essential to reduce the energy consumption of the components as much as possible.

However, motors typically have relatively high power consumption. A data storage device accessing a removable storage medium, such as an optical disc, inherently requires a motor to spin the optical disc during the reading or writing operations. However, this tends to result in a relatively high power consumption, and in particular the energy consumption associated with spin-up of the disc and jumps between different reading or writing positions is significant.

Accordingly, a data storage device having increased motor control and/or a reduced power/energy consumption is advantageous. In particular, a data storage device having means for operating a motor of the data storage device with lower energy consumption would be advantageous.

Accordingly, the invention seeks to provide an improved data storage device and method of generating a motor control signal system for motor control, and preferably seeks to mitigate, alleviate or eliminate one or more of the above-mentioned disadvantages singly or in any combination.

According to a first aspect of the invention, there is provided a data storage device comprising:
a data interface for transferring data from or to a spinning data storage disc at a first data rate;
a motor for spinning the disc;
means for determining a preferred motor speed change time; and
motor control means for controlling the motor to perform the speed change in response to the preferred motor speed change time.

The inventors of the current invention have realized that a number of parameters may depend on the motor speed change time, and that an improved performance can be achieved by controlling the motor to change speed in response to a preferred motor speed change time. The invention enables an improved control of motor associated parameters for a data storage device thereby allowing for improved performance of the data storage device. The motor speed may specifically be a rotational frequency associated with a reading or writing position of the data storage disc. The data storage device may specifically be a data reading device for reading data from the disc, a data writing device for writing data unto the disc or a combined reading and writing device capable of both reading and writing data from and to the disc.

According to a feature of the invention, the means for determining is operable to determine the preferred motor speed change time in response to at least one energy consumption associated with the preferred motor speed change time.

Preferably, the preferred motor speed change time is determined such that energy consumption is reduced or minimized. The preferred motor speed change time may specifically be determined by determining the energy consumption of all or parts of the data storage device as a function of the preferred motor speed change time and selecting the preferred motor speed change time as that resulting in the lowest energy consumption. Hence battery life and/or size of the data storage device may be improved.

According to another feature of the invention, the at least one energy consumption comprises an energy consumption of the motor.

The inventors have realized that for very slow speed changes of a motor, a high energy consumption results due to the long time it takes for the motor to reach the desired speed. Typically, data cannot be read from or written to the disc during the speed change interval, while at least part of the system does consume energy. Furthermore, the inventors have realized that for very fast motor speed changes, energy consumption increases due to increased losses of the motor. The invention allows for a preferred motor speed change time to be determined in response to these parameters whereby a reduction or optimization of power consumption of the motor can be achieved. As the energy consumption of a motor typically is one of the most significant energy consumptions of a data storage device, a significant reduction of the energy consumption of the entire data device is achieved thereby enabling extended battery life and/or reduced size of the data storage device.

According to another feature of the invention, the data storage device further comprises an output buffer coupled to the data interface and operable to receive data from the data interface at the first data rate in a first time interval and to output data at a lower data rate for a longer time interval.

Data may typically be read from a data storage disc at much higher data rates than required from the data storage device, and an output buffer allows for rate adjustment between these. Specifically, the output buffer may allow that the motor is only active during the first time interval thereby allowing for a significant power reduction. This will however result in an uneven non-continuous operation of the motor and thereby in many motor speed changes. Therefore, controlling the motor in response to a preferred motor speed change time will in this case be of particular importance.

According to another feature of the invention, the at least one energy consumption comprises a first energy consumption associated with the first time interval and a second energy consumption associated with the second time interval.

This allows for the preferred motor speed change time to be optimized while allowing a trade off between the lengths of the individual intervals and thus allows for an improved energy consumption reduction. The at least one energy consumption may be the energy consumption of the whole interval but is preferably the energy consumption of a sub-interval. This sub-interval may be of a constant size such that the energy consumption corresponds to a power consumption or may be the energy consumption of a time interval which is either part of the first or second time interval depending on the value of the preferred motor speed change time.

According to another feature of the invention, the data storage device further comprises means for reducing the energy consumption of the motor outside the first interval and the second energy consumption is an energy consumption of the data storage device when the energy consumption of the motor is reduced. Preferably, the first energy consumption may comprise an energy consumption of the data storage device excluding an energy consumption of the motor. The first energy consumption may specifically comprise a first component corresponding to the energy consumption of the data storage device excluding an energy consumption of the motor and a second component corresponding to the energy consumption of the motor.

Preferably, the preferred motor speed change time is determined in response to the energy consumption in time intervals when the motor is active and intervals when the motor is not active. The power consumption in each time interval is typically significantly different and by controlling the motor speed change time in response to the preferred motor speed change time, when taking into account the different energy consumptions in the different time intervals, provides increased possibility of optimizing the control of the motor and thus the performance of the data storage device.

According to another feature of the invention, the data storage device further comprises means for measuring at least one energy consumption parameter of an element of the data storage device and the at least one energy consumption comprises the at least one energy consumption parameter.

Preferably, the at least one energy consumption parameter may be measured real time or sufficiently frequently for the measured value to be a reasonable representation of the current conditions of the element of the data storage device. The energy consumption of the element is preferably determined from the measured parameter. The energy consumption parameter may for example be a current drawn by the motor in different operating conditions. The energy consumption parameter may also be an indirect parameter, such as an operating temperature, wherefrom an energy consumption can be calculated or estimated.

This allows for a highly efficient operation of the motor which may be dynamically adapted to the currently prevailing conditions. Significantly reduced power consumption may be achieved.

According to another feature of the invention, the preferred motor speed change time is a disc spin up time. The spin up of a disc is a particularly frequent and energy consuming operation and therefore a particular advantageous energy consumption reduction may be achieved by determining a preferred motor speed change time for this operation.

According to another feature of the invention, the motor speed is dependent on the disc access position and the preferred motor speed change time is associated with a step change in the disc access position between a first disc access position and a second disc access position. The disc access positions may specifically be disc reading positions or disc writing positions.

In this case the preferred motor speed change time may be considered a jump time for the data storage device jumping from one access position to another. The jump time is a particularly frequent and energy consuming operation and therefore a particular advantageous energy consumption reduction may be achieved by determining a preferred motor speed change time for this operation.

According to another feature of the invention, the means for determining is operable to determine the preferred motor speed change time in response to a rotational frequency difference between a first rotational frequency of the disc associated with the first disc access position and a second rotational frequency of the disc associated with the second access position.

Motor parameters, such as the energy consumption of the motor, may typically be particularly sensitive and dependent on the amount of the change between different operating conditions. Determining the preferred motor speed change time in response to a step in rotational frequency allows for the optimal value of the preferred motor speed change time to be determined for the specific jump size (e.g. the size of the step change in rotational frequency). The first rotational frequency may specifically be a rotational frequency when the motor is not active and may specifically be substantially zero.

According to another feature of the invention, the data storage device further comprises a data storage comprising associations between the preferred motor speed change time and the rotational frequency difference and the means for determining is operable to determine the preferred motor speed change time by accessing the data storage.

This provides for a low complexity implementation of means for determining the preferred motor speed change time. It furthermore allows for the relationship between the preferred motor speed change time and the rotational frequency difference to be stored in the data storage device during manufacture.

According to another feature of the invention, the data storage device further comprises:
means for outputting information related to the preferred motor speed change time;
input means for receiving motor control information; and
the motor control means is operable to control the motor in response to the motor control information.

This allows for external means to control or assist in the control of the motor. For example, this may allow an application to select a trade off between energy consumption and other parameters to suit the specific application. It may for example allow for the preferred motor speed change time to be dependent on the remaining battery life for a device comprising the data storage device. Hence, improved performance of an application or device comprising the data storage device may be achieved.

According to another feature of the invention, the motor control means is further operable to control the motor in response to the data read from the data storage disc.

This allows, for example, for a motor operation dependent on which disc is being read or allows for an application to control or assist in the control of the motor. Thus, specifically, an application utilizing the data from the data storage disc may implement all or part of the control means.

According to another feature of the invention, the data storage device is an optical data storage device and the data storage disc is an optical storage disc.

This allows for a highly efficient optical disc storage device having low energy consumption. The data storage device may specifically be a Small Form Factor Optical (SFFO) disc reader.

According to a second aspect of the invention, there is provided a method of generating a motor control signal for a data storage device having a motor for spinning a data storage disc; the method comprising the steps of: transferring data to or from the data storage disc at a first data rate; determining a preferred motor speed change time; and generating a motor control signal operable to control the motor to perform the speed change in response to the preferred motor speed change time.

These and other aspects, features and advantages of the invention will be apparent from and elucidated with reference to the embodiment(s) described hereinafter.

An embodiment of the invention will be described, by way of example only, with reference to the drawings, in which:

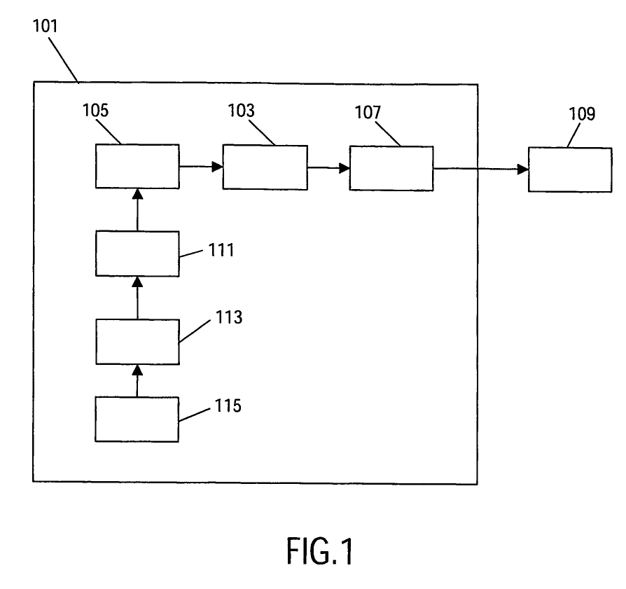

FIG. 1 illustrates a block schematic of a data storage device in accordance with an embodiment of the invention;

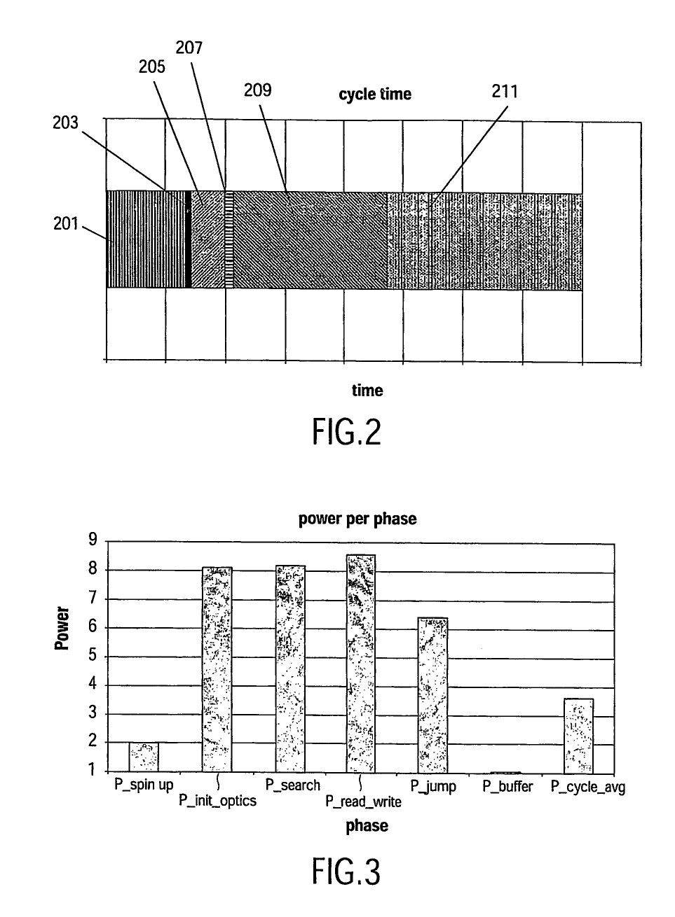

FIG. 2 illustrates an operational cycle for a data storage device in accordance with an embodiment of the invention;

FIG. 3 illustrates an example of power consumption during different phases of a data storage device in accordance with an embodiment of the invention;

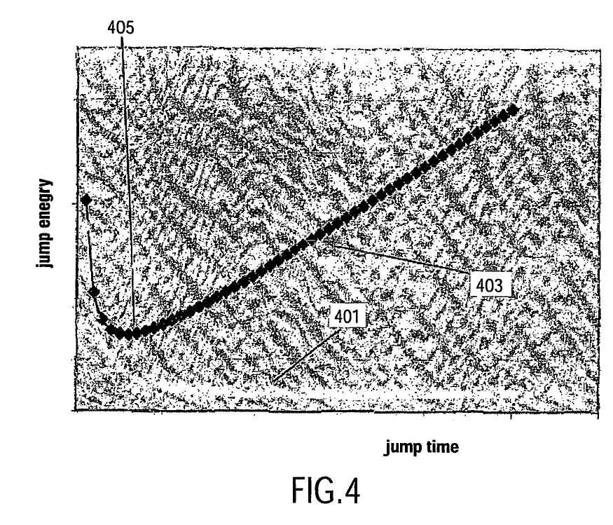

FIG. 4 illustrates an example of an energy consumption as a function of a preferred motor speed change time for a disc jump in a data storage device in accordance with an embodiment of the invention; and

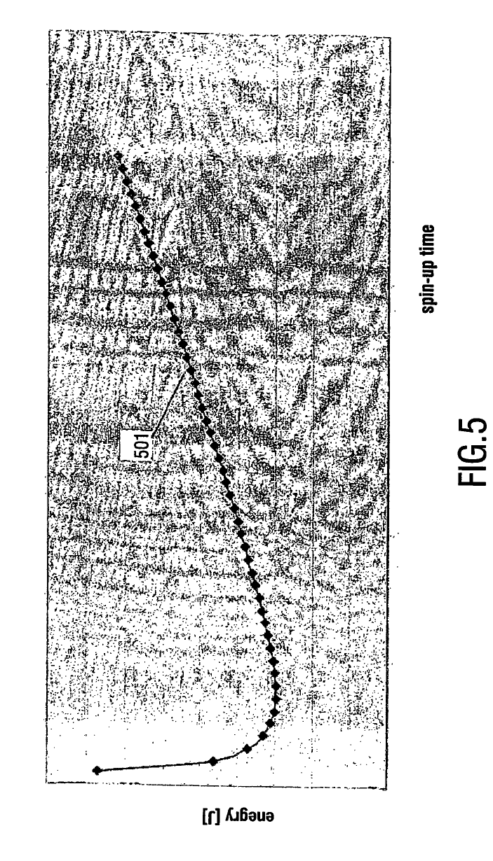

FIG. 5 illustrates an example of an energy consumption as a function of a preferred motor speed change time for a disc spin up in a data storage device in accordance with an embodiment of the invention.

The following description focuses on an embodiment of the invention applicable to a data storage device for an optical storage disc, such as a CD, DVD or in particular a Small Form Factor Optical (SFFO) disc. However, it will be appreciated that the invention is not limited to this application and may be used in association with many other data storage devices including for example data storage devices for magnetic storage discs or magneto-optical storage discs.

The following description will focus on an embodiment applicable to a data reading device wherein data is transferred from the storage disc but it will be apparent that the invention is equally applicable to for example a data-writing device wherein data is transferred to the storage disc.

FIG. 1 illustrates a block schematic of a data storage device 101 in accordance with a preferred embodiment of the invention.

In accordance with the preferred embodiment of the invention, the data storage device 101 comprises a data interface 103 which is operable to read data from a spinning data storage disc, which in the preferred embodiment is an optical disc 105. In the preferred embodiment, the data storage device 101 is a Small Form Factor Optical (SFFO) data storage device and the optical disc 105 is an SFFO disc.

It will be apparent, that the data storage device 101 comprises the necessary mechanical arrangement for loading, securing and unloading the optical disc during operation. Any suitable mechanical arrangement may be used, and the person skilled in the art may apply any suitable approach or design criteria suitable for the specific application. Various mechanical arrangements for implementation of data storage devices for spinning storage discs are well known in the art and will for the sake of clarity and brevity not be described further here.

The data interface 103 comprises means for reading data from a spinning optical disc 105 by reading the stored optical information using a laser. The optical data is converted into an electrical data signal. The data interface 103 may further comprise error correcting functionality as is well known in the art. In the preferred embodiment, the data interface 103 is coupled to an output buffer 107.

The data read from the optical disc is typically a discontinuous data stream, wherein intervals of outputting data are separated by intervals wherein no data is output from the data interface 103. These non-active intervals may for example correspond to intervals required for changing the reading position on the disc, for spinning up the disc etc. Specifically, the data rate at which data is read from the disc may be significantly higher than the output rate required from the data storage device, and therefore data may be read from the disc in short bursts interspersed by non-active power down intervals. The output buffer provides for a continuous data output and allows for the rate adaptation between the maximum data rate of the data interface 103 and the average data rate of the buffer output.

In other embodiments, the data storage device 101 does not comprise an output buffer and instead a discontinuous data stream may be output from the data interface.

The output buffer 107 further comprises an interface suitable for outputting the data stream to an external source, such as for example a computer, a PDA, a personal music system or a mobile phone.

The data storage device 101 also comprises a motor 111 for spinning the optical disc 105. Any suitable arrangement may be used for enabling the motor to spin the disc, but in the preferred embodiment, the axis of the motor is rotationally and mechanically coupled to a spindle to which the optical disc 105 is secured. In the preferred embodiment, there is a direct correspondence between the speed or rotational frequency of the optical disc 105 and the speed or rotational frequency of the motor 111.

In the preferred embodiment, the motor is connected to a motor controller 113 which is operable to control the motor and specifically the speed (or rotational frequency) of the motor and thereby the speed (or rotational frequency) of the spinning disc. Specifically, the motor controller 113 is operable to generate an electrical voltage and/or current which when applied to the motor 111 will cause the motor 111 to have the desired speed. The motor speed may thus be dynamically controlled by the motor controller 113 dynamically varying the value of the electrical control signal.

In the preferred embodiment, the motor controller 113 comprises measurement means, control loop feed back means etc for ensuring a suitable motor speed during data reading operations as is well known in the art. Specifically during a data reading operation, the motor controller 113 may receive control feed back from the data storage device. The feedback may be used to control the motor speed such that the rotational frequency of the spinning disc is suitable for the current data reading position.

The motor controller 113 is in the preferred embodiment coupled to a speed change processor 115 operable to determine a preferred motor speed change time. Thus in the preferred embodiment, when a speed change of the motor is required by the data storage device 101, for example when the motor is restarted following an inactive interval, the speed change processor 115 is activated. It then proceeds to determine the preferred duration for the motor to change the speed from the current speed to the desired speed. This preferred motor speed change time is then fed to the motor controller 113 which is operable to control the motor 111 to achieve the motor speed change in substantially the preferred motor speed change time.

The inventors have realized that many parameters associated with a change in the speed of a motor depend on the duration of the speed change, and that advantageous performance can be achieved by controlling the motor of a data storage device in response to the preferred motor speed change time. For example, the value of a specifically critical parameter may be determined as a function of the motor speed change time, and a preferred time for the motor speed change may be determined as that resulting in the optimal value of the critical parameter. The motor may subsequently be controlled to achieve the motor speed change in substantially that time, thereby resulting in the optimal effect on the critical parameter.

It will be appreciated that any suitable parameter, criteria or algorithm may be used for determining the preferred motor speed change time. However, in the preferred embodiment, the preferred motor speed change time is determined in response to one or more energy consumptions associated with the preferred motor speed change time.

For example, an energy consumption of the motor may be determined in response the preferred motor speed change time. An extremely short motor speed change time requires that high voltages and/or currents be fed to the motor thereby resulting in increased losses and thus a relatively high-energy consumption. However, for long motor speed change times, the motor is operational for a long time (during which data are not read from the disc) and accordingly the energy consumption of this interval will become high.

Therefore, an optimal motor speed change time exists at which the energy consumption is minimum.

In one embodiment, the motor may be pre-characterized such that the loss may be predetermined for different motor speed change times. In this case, the speed change processor 1 15 may simple determine the preferred motor speed change time in response to a table look up. In other embodiments, parameters and characteristics of the motor may be stored and used by the speed change processor 1 15 to calculate the preferred motor speed change time.

In the preferred embodiment, the output buffer allows for the data from the data interface to be received at a first data rate in a first time interval. The data may be outputted at a lower data rate for a longer time interval. For example, the data rate from the data interface 103 may be ten times higher than the output data rate of the output buffer 107. In this example, data may only be read for approximately 10% of the time and the motor may be shut down for the remaining time. The preferred motor speed change time may in this case be determined by taking into account the different power or energy consumption in the different time intervals. Thus, the preferred motor speed change time may for example be determined in response to the relative energy consumption in different intervals corresponding to different operating conditions of the data storage device.

Specifically, the preferred motor speed change time may be determined in response to energy consumption in an interval wherein the motor is active compared to a time intervals wherein the motor is operating at a reduced power or specifically when the motor is shut down.

In the preferred embodiment, the preferred motor speed change time is determined for a disc spin up time. For a data storage device with an output buffer operating in a discontinuous mode as described, the motor is shut down in every cycle, and thus whenever a new reading operation is initiated, the disc must initially be spun up to the desired rotational frequency. The energy consumption of this spin up will depend on the preferred motor speed change time, and therefore the energy consumption of this interval may be minimized by determining the preferred motor speed change time.

In the preferred embodiment, a preferred motor speed change time is additionally determined for jump times associated with the data reading operation. In many optical disc reading systems, the disc reading data rate is constant. As the radius of the disc reading position varies, this results in the rotational frequency of the disc being dependent on the reading position. Thus, typically, the motor speed is dependent on the disc reading position and step changes in the disc reading position between a first disc reading position and a second disc reading position may occur. When such a jump occurs in the reading position, a speed change of the motor is required. Such jumps may occur many times during a single disc reading interval. In accordance with the preferred embodiment of the invention, the preferred motor speed change time for some or all of these jumps are determined and the motor is controlled accordingly.

Specifically, the preferred motor speed change time is preferably determined at least in response to characteristics of the motor and the rotational frequency difference between a first rotational frequency of the disc associated with the first disc reading position and a second rotational frequency of the disc associated with the second reading position. Thus, when a jump in reading position is required, the information is passed to the speed change processor 115 which determines the preferred motor speed change time as that which results in the lowest energy consumption of the jump taking into account the motor characteristics and the difference in rotational frequency required for a jump from the first reading position to the second reading position (as well as e.g. the energy consumption of other parts of the data storage device). For example, if the difference in rotational frequency is low, a short preferred motor speed change time may be determined and if the change in rotational frequency is high, a longer preferred motor speed change time may be determined.

In one embodiment, the speed change processor 115 may comprise a look up table comprising associations between the preferred motor speed change time and the rotational frequency difference. In this embodiment, the speed change processor 115 is operable to determine the preferred motor speed change time by accessing the data storage.

Specifically, the look up table may comprise different jump distances associated with the most energy efficient jump times. Entries to this table can be calculated from a motor power curve and the power values from other parts of the system. The values may be calculated real time but are preferably precalculated and stored in the table during manufacture. When a jump is required, the most power efficient jump time is fetched from this table by the speed change processor 115 and used as the preferred motor speed change time.

In some embodiments, the data storage device further comprises means for measuring at least one energy consumption parameter of an element of the data storage device. For example parameters associated with the power or energy consumption of the motor and/or other parts of the data storage device may be measured real time and used to calculate the preferred motor speed change time. This will allow for the preferred motor speed change time to be calculated while taking into account the actual rather than predicted values of various energy consumption parameters.

The measurement is preferably a direct measurement of power or energy consumption, such as for example a measurement of the current drain of the motor for different motor speed change times. Thus, whenever a motor speed change occurs, the energy consumption of the motor may be measured and used to continuously update data associating motor energy consumption and motor speed change times. In other embodiments, an indirect measure may be performed. For example, different power curves may exist for a motor dependent on the temperature of the motor. Accordingly, the temperature of the motor may be measured and used to derive a motor energy consumption.

A specific example of an embodiment directed to a small form factor optical (SFFO) disc system for portable applications is described in more detail in the following. For such an application it is important that the data storage device has very small dimensions (e.g. 36.4×42.8×5 mm). Furthermore, the storage capacity of the discs should be high (1 GB or higher), and the power dissipation of the data storage device should be low. To keep the dissipation as low as possible, it is advantageous to use knowledge of the power dissipation of different parts of the data storage device at certain times. The specific embodiment is directed to a reduction of power during jumps to different locations on the disc when reading or writing a file and during spin-up of the disc just before reading or writing.

For SFFO streaming applications, the bit rates are typically in the order of 0.5 to 1 Mbps, while the data storage device is typically capable of handling data rates up to 36 Mbps. To save power it is therefore advantageous to use an output buffer. Once in a while, the buffer is filled at a data rate of 36 Mbps, after which the data storage device is stopped almost completely to allow the buffer to be read out at a rate of e.g. 1 Mbps (the application data rate). This way the data storage device is only active during part of the time, which results in a significant power reduction. This approach leads to a data storage device that has an operational cycle containing a certain number of phases. For instance, the cycle may comprise a spin up phase in which the spindle motor accelerates the disc to the desired rotational frequency, an initializing optics phase in which the optics are initialized before read/write, a (number of) search phase(s) in which the correct physical address on the disc is searched, a (number of) read/write phase(s), a (number of) jump phase(s) in which a jump is made to a different location on the disc and finally a buffer phase in which the data storage device is largely inactive while the buffer is read out.

FIG. 2 illustrates an operational cycle for a data storage device in accordance with this approach. FIG. 2 illustrates one cycle, which is divided in the different phases. FIG. 2 thus illustrates an example of a cycle comprising a spin up phase 201, an initializing optics phase 203, a (number of) search phase(s) 205, a (number of) read/write phase(s) 207, a (number of) jump phase(s) 209 and a buffer phase 211 (FIG. 2 illustrates the different jump/search/read/write phases grouped together. For example, if a plurality of jumps occurs these are all grouped together in phase 209 and thus the total duration of phase 209 is the total jump time per cycle (i.e. the sum total of the individual jump times of all jumps in the cycle)).

FIG. 3 illustrates an example of the power consumption during the different phases illustrated in FIG. 2 (and arranged in the same order as in FIG. 2). As can be seen, the power consumption during the buffer interval 201 is significantly lower than the power consumption during the phases in which the motor is active. The energy consumption of each interval or phase may be determined by multiplying the power consumption illustrated in FIG. 3 by the duration of the phase as illustrated in FIG. 2.

In the following, a specific example of how the preferred motor speed change time may determined for the specific embodiment is given. Specifically, a preferred motor speed change time for a jump time associated with a step change in the reading position between a first reading position and a second reading position is given.

The preferred jump time depends on the desired rotational frequency, the acceleration of the spindle motor and the number of jumps to be taken per cycle. For a given cycle time (given by the user data rate and the buffer size), an increment of the jump time means a reduction of the buffer time (i.e. it is assumed that the other times are substantially fixed). Since the jump power is much higher than the buffer power, it is preferable to make the jump time as short as possible. However, for constant linear velocity (CLV) systems (i.e. systems in which data passes the laser spot with the same velocity regardless of the reading position), a small jump time means that the acceleration/deceleration of the spindle motor needs to be performed very fast thereby increasing the energy dissipation in the motor and motor driver during the jump. To find the lowest energy consumption, the following equation needs to be solved:
E_{jump,CLV}=min((P_{system,jump}−P_{system,buffer}+P_{motor,spin}_{_{—}}_{up/down}(t))tⱼᵤₘₚ)
wherein:
tⱼᵤₘₚ is the preferred duration of the jump phase;
P_{system,jump} is the power consumption of all parts of the data storage device, except the motor, that are active during a jump;
P_{system,jump} is the power consumption of all the parts of the data storage device that are active during the buffer phase; and
P_{motor,spin}_{_{—}}_{up/down} is the power consumed in the motor, given that the spin-up/down of the motor during a jump has to be achieved in tⱼᵤₘₚ. This is of course dependent on the required change in motor frequency, and thus the jump distance.

The preferred motor speed change time tⱼᵤₘₚ can be found as follows.

First the motor power is calculated as a function of time:

$$\begin{matrix}{P}_{mot} ( t ) = iu \\ = i ( {iR}_{e} + {V}_{backEMF} ) \\ = {i}^{2} {R}_{e} + {iV}_{backEMF} \\ = {( \frac{{T}_{air} + {T}_{bearing} + {T}_{spin - up}}{{K}_{t}} )}^{2} {R}_{e} + \\ \frac{{T}_{air} + {T}_{bearing} + {T}_{spin - up}}{{K}_{t}} {V}_{backEMF} \\ = {( \frac{{T}_{air} + {T}_{bearing} + \frac{{J}_{tot} {ϖ}_{ttm}}{t}}{{K}_{t}} )}^{2} {R}_{e} + \\ \frac{{T}_{air} + {T}_{bearing} + \frac{{J}_{tot} {ϖ}_{ttm}}{t}}{{K}_{t}} {V}_{backEMF} \\ = {( \frac{{T}_{air} + {T}_{bearing}}{{K}_{t}} + \frac{{J}_{tot} {ϖ}_{ttm}}{{K}_{t} t} )}^{2} {R}_{e} + \\ \frac{( {T}_{air} + {T}_{bearing} ) {V}_{backEMF}}{{K}_{t}} + \frac{{J}_{tot} {ϖ}_{ttm}}{{K}_{t} t} {V}_{backEMF} \\ = {( \frac{{T}_{air} + {T}_{bearing}}{{K}_{t}} )}^{2} {R}_{e} + \frac{( {T}_{air} + {T}_{bearing} ) {V}_{backEMF}}{{K}_{t}} + \\ ( \frac{2 ( {T}_{air} + {T}_{bearing} )}{{K}_{t}^{2}} {R}_{e} + \frac{{V}_{backEMF}}{{K}_{t}} ) {J}_{tot} {ϖ}_{ttm} \cdot \frac{1}{t} + \\ {( \frac{{J}_{tot} {ϖ}_{ttm}}{{K}_{t}} )}^{2} {R}_{e} \cdot \frac{1}{{t}^{2}}\end{matrix}$$

wherein:
Tₐᵢᵣ is the air friction torque;
T_{bearing} is the bearing friction torque;
Jₜₒₜ is the total inertia of disc, hub and motor;
ωₜₜₘ is the total change in rotational frequency in a jump;
Kₜ is a motor constant;
Re is the electrical resistance of the motor, and
V_{backEMF}=Kₜ^{≠ω}ₜₜₘ.
Setting

$$a = {( \frac{{T}_{air} + {T}_{bearing}}{{K}_{t}} )}^{2} {R}_{e} + \frac{( {T}_{air} + {T}_{bearing} ) {V}_{backEMF}}{{K}_{t}}$$

$$b = ( \frac{2 ( {T}_{air} + {T}_{bearing} )}{{K}_{t}^{2}} {R}_{e} + \frac{{V}_{backEMF}}{{K}_{t}} ) {J}_{tot} {ϖ}_{ttm}$$

$$c = {( \frac{{J}_{tot} {ϖ}_{ttm}}{{K}_{t}} )}^{2} {R}_{e}$$

yields

$${P}_{mot} ( t ) = a + \frac{b}{t} + \frac{c}{{t}^{2}}$$

The total (extra) energy used during a jump is given by,

$$\begin{matrix}{E}_{tot} ( t ) = {P}_{mot} ( t ) t ( {P}_{system , jump} - {P}_{system , buffer} ) t \\ = ( a + {P}_{system , jump} - {P}_{system , buffer} ) t + b + \frac{c}{t}\end{matrix}$$

To find the minimum the first derivative of the above equation is determined:

$$\frac{{dE}_{tot} ( t )}{t} = 0 \\ ⇔ 0 = ( a + {P}_{system , jump} - {P}_{system , buffer} ) - \frac{c}{{t}^{2}} \\ ⇔ t = \sqrt{\frac{c}{a + {P}_{system , jump} - {P}_{system , buffer}}}$$

Hence, the preferred motor speed change time may be determined from the described parameters and motor characteristics.

The calculation may be made more accurate by talking further parameters into account. For example, in the described calculation, the motor driver power consumption is not taken into account In other embodiments, simpler calculations may be performed and fewer parameters taken into account.

FIG. 4 illustrates an example of the energy consumption as a function of a preferred motor speed change time for a data storage device in accordance with an embodiment of the invention. In FIG. 4, curve 401 illustrates the energy consumption of the motor as a function of the jump time. Curve 401 shows a decrease in energy usage when the available jump time gets longer. Curve 403 illustrates the energy consumption of the system except the motor. The power difference between the jump- and buffer-phase for the system except motor is constant, therefore resulting in a linearly increasing curve for the extra energy usage as a result of a jump for a given jump time. Curve 405 illustrates the total energy usage in the data storage device during a jump as a function of the jump time length. As can be seen, the energy consumption has a clear minimum corresponding to a certain jump time.

The most energy efficient spin-up time can be found in a similar way by determining the energy minimum and the corresponding preferred motor speed change time tₛₚᵢₙ₋ᵤₚ:
Eₛₚᵢₙ_{_{—}}ᵤₚ=min((P_{system,spin-up}−P_{system,buffer}+P_{motor,spin}_{_{—}}_{up/down}(t))tₛₚᵢₙ₋ᵤₚ)

FIG. 5 illustrates an example of the energy consumption as a function of a preferred motor speed change time for a disc spin up in a data storage device 101 in accordance with an embodiment of the invention. The total energy consumption is illustrated by curve 501 and clearly shows a minimum.

The most energy efficient spin-up time is generally larger than the most energy efficient jump time. The reason for this, is that during spin up, a smaller fraction of the total system needs to be active than during a jump, i.e. the difference in system power between buffer and spin-up phase is smaller than between buffer and jump phase, allowing the motor to take more time to perform the spin-up. In other words, for a spin up, the power dissipation of the motor plays a larger role in the total dissipation than for a jump.

In some embodiments, the data storage device may further comprise a control output interface, for outputting information related to the preferred motor speed change time, and a control input interface for receiving motor control information. In these embodiments, the motor controller 113 is operable to further control the motor in response to the motor control information received by the input means.

Specifically, various tables and characteristics used by the speed change processor 115 in determining the preferred motor speed change time may be made accessible to an application using the data storage device. This will allow the application to influence the behavior of the data storage device. Hence, the application using the data storage device 101 may specifically perform the trade offs between different parameters, such as for example between energy consumption and data rates.

In some embodiments, the motor control means is further operable to control the motor in response to the data read from the optical disc. For example, an application may be retrieved from the optical disc and this application may comprise all or part of the described functionality of the motor controller 113 and the speed change processor 115. Thus specifically, the application may operate the motor of the data storage device thereby allowing for increased flexibility.

The invention can be implemented in any suitable form including hardware, software, firmware or any combination of these. However, preferably, the invention is at least partially implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A data storage device (101) comprising:
a data interface (103) for transferring data from or to a spinning data storage disc (105) at a first data rate;
a motor (111) for spinning the data storage disc (105);
means (115) for determining a preferred motor speed change time; and
motor control means (113) for controlling the motor (111) to perform a speed change in response to the preferred motor speed change time.

2. A data storage device (101) as claimed in claim 1 wherein the means (115) for determining is operable to determine the preferred motor speed change time in response to at least one energy consumption associated with the preferred motor speed change time.

3. A data storage device (101) as claimed in claim 2 wherein the at least one energy consumption comprises an energy consumption of the motor (111).

4. A data storage device (101) as claimed in claim 2 further comprising an output buffer (107) coupled to the data interface (103) and operable to receive data from the data interface (103) at the first data rate in a first time interval and to output data at a lower data rate for a longer time interval.

5. A data storage device (101) as claimed in claim 4 wherein the at least one energy consumption comprises a first energy consumption associated with the first time interval and a second energy consumption associated with the second time interval.

6. A data storage device (101) as claimed in claim 5 further comprising means for reducing the energy consumption of the motor (111) outside the first interval and the second energy consumption is an energy consumption of the data storage device (101) when the energy consumption of the motor (111) is reduced.

7. A data storage device (101) as claimed in claim 5 wherein the first energy consumption is an energy consumption of the data storage device (101) excluding an energy consumption of the motor (111).

8. A data storage device (101) as claimed in claim 2 further comprising means for measuring at least one energy consumption parameter of an element of the data storage device (101) and the at least one energy consumption comprises the at least one energy consumption parameter.

9. A data storage device (101) as claimed in claim 1 wherein the preferred motor speed change time is a disc spin up time.

10. A data storage device (101) as claimed in claim 1 wherein a motor speed is dependent on a disc access position and the preferred motor speed change time is associated with a step change in the disc access position between a first disc access position and a second disc reading position.

11. A data storage device (101) as claimed in claim 1 wherein the means for determining ( 15) is operable to determine the preferred motor speed change time in response to a rotational frequency difference between a first rotational frequency of the data storage disc (105) associated with the first disc access position and a second rotational frequency of the data storage disc (105) associated with the second access position.

12. A data storage device (101) as claimed in claim 11 further comprising a data storage comprising associations between the preferred motor speed change time and the rotational frequency difference and the means for determining (1 15) is operable to determine the preferred motor speed change time by accessing the data storage.

13. A data storage device (101) as claimed in claim 1 further comprising means for outputting information related to the preferred motor speed change time; input means for receiving motor control information;
and wherein the motor control means (113) is operable to control the motor in response to the motor control information.

14. A data storage device (101) as claimed in claim 1 wherein the motor control means (113) is further operable to control the motor in response to data read from the data storage disc (105).

15. A data storage device (101) as claimed in claim 1 wherein the data storage device (101) is an optical data storage device and the data storage disc (105) is an optical storage disc.

16. A method of generating a motor control signal for a data storage device (101) having a motor (111) for spinning a data storage disc (105), the method comprising the steps of:
transferring data to or from the data storage disc (105) at a first data rate;
determining a preferred motor speed change time; and
generating a motor control signal operable to control the motor (111) to perform a speed change in response to the preferred motor speed change time.

17. A computer program enabling the carrying out of a method according to claim 16.

18. A record carrier comprising a computer program as claimed in claim 17.
